(19) United States
(12) Patent Application Publication
(10) Pub. No.: US 2004/0250700 A1
(43) Pub. Date: Dec. 16, 2004

(54) Method and apparatus for treating refuse with steam

(76) Inventor: Regis Phillip Renaud, Silverado, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/778,012

(22) Filed: Feb. 12, 2004

Related U.S. Application Data
(63) Continuation-in-part of application No. 10/283,399, filed on Oct. 29, 2002, now abandoned.
Application No. 10/283,399 is a division of application No. 09/838,442, filed on Apr. 19, 2001, now Pat. No. 6,471,443.
(60) Provisional application No. 60/198,196, filed on Apr. 19, 2000.

(51) Int. Cl. B30B 15/34

(52) U.S. Cl. 100/38

(57) ABSTRACT

A method of injecting steam into a landfill is provided. The steam enhances methane gas production in the landfill during the anaerobic phase, accelerates decomposition/biodegradation of the organic component of the trash prism during both the aerobic and anaerobic phases, and increases the rate of settlement of the landfill. A method of introducing a gaseous anaerobic fertilizer into the landfill is also provided. The fertilizer accelerates the decomposition/biodegradation of the organic component of the trash prism. A method of reducing the volume of a plastic component of the trash prism is provided, wherein the temperature and pressure of injected steam are raised to a level sufficient to melt plastic. Methods and apparatus for reducing the volume of a quantity of refuse prior to placing the refuse in a landfill are provided. The refuse is heated with steam and also compacted. The heat melts plastic in the refuse, and the compaction increases the quantity of refuse that can be placed into a given landfill.

### RELATED APPLICATIONS

This application is a continuation-in-part of U.S. application Ser. No. 10/283,399, filed on Oct. 29, 2002, which is a divisional application of U.S. application Ser. No. 09/838,442, filed on Apr. 19, 2001, which claims the benefit of U.S. Provisional Application Ser. No. 60/198,196, filed on Apr. 19, 2000, all of which are incorporated herein by reference.

### BACKGROUND OF THE INVENTION

1. Field of the Invention

The present invention relates to methods and apparatus for treating refuse, both before and after the refuse is placed in a landfill.

2. Description of the Related Art

In general, landfills are constructed using the “dry tomb” method, in which the refuse in the landfill is kept as dry as possible both during construction and when the landfill is closed and capped. This method minimizes the possibility of leachate leaking into groundwater and contaminating it. However, dry conditions are not conducive to the decomposition of the organic refuse. Instead, the organic refuse remains dormant for decades until water infiltrates the landfill in an uncontrolled and natural manner. The water infiltration may cause gas migration, which can lead to groundwater contamination.

The slow decomposition of the organic refuse under dry conditions also slows the settling of the landfill and hinders the production of methane gas, which is a natural by-product of anaerobic (oxygen-starved) decomposition of organic material. Delaying the complete settling of a landfill is disadvantageous, because until the landfill settles, the landfill site is not useful for any purpose other than a garbage dump. In addition, methane is useful as a fuel to produce electricity, for example. Therefore, it would be of great benefit to encourage the rapid decomposition of the organic component of the landfill in order to more efficiently capture the methane produced thereby.

Moisture accelerates decomposition of organic refuse, but does not accelerate the decomposition of the non-organic refuse. Thus, addition of moisture to the trash prism increases the purity of methane extracted from the landfill, because the proportion of decomposing organic refuse to decomposing inorganic refuse is higher as compared to a dry trash prism. The extracted methane is thus more useful because it has a higher Btu value. If the refuse is flooded with water, however, the gas becomes bound up in the liquid and is difficult to recover. Further, introducing water after a landfill has been closed cools the refuse. But decomposition proceeds best at a temperature around 100° F. Therefore, a method of introducing moisture into a trash prism that does not flood the trash prism or cool the trash prism would be of great benefit to the landfill-management industry.

One useful method of monitoring conditions within a landfill as a piezo-penetrometer test (PPT) profile. A PPT is an instrument having sensors that measure several parameters within the landfill as the instrument is hydraulically pushed into the landfill. Parameters such as soft and dense layers, vacuum, and gas and liquid pressure are recorded in a computer. This data is then used to develop a three-dimensional profile of the in-situ conditions within the landfill.

PPT profiles of landfills have shown that liquids tend to collect on top of dense and daily cover layers inside landfills, and that gases collect underneath these layers. Dense and daily cover layers are the component of the landfill that is added at the end of each day during the active phase of the landfill. The refuse deposited into the landfill each day is covered by a layer of dirt or a suitable dirt alternative. The non-uniform distribution of liquid around these layers only causes the biodegradation of the organic material in the immediate area of the liquid, rather than throughout the entire trash prism. Thus, a method of evenly distributing moisture throughout the trash prism would greatly enhance the biodegradation of the organic material in the landfill.

U.S. Pat. No. 5,695,641 to Cosulich et al., discloses a method and apparatus for enhancing methane production in a landfill. The method comprises injecting ammonia into the landfill to thereby reduce residual oxygen levels, provide a rich source of nitrogen nutrient for the anaerobic microbe population and increase the pH. The ammonia is injected via injection wells, and may be injected in any form, diluted by a non-oxidizing carrier gas or in aqueous form. The Cosulich method, however, does not suggest the benefits gained by increasing the moisture content of the landfill, or address the detrimental effects of lowering the temperature of the landfill by introducing water.

U.S. Pat. No. 6,024,513 to Hudgins et al., discloses a method of decomposing municipal solid waste (MSW) within a landfill by converting the landfill to aerobic degradation in the following manner: (1) injecting air via the landfill leachate collection system; (2) injecting air via vertical air injection wells installed within the waste mass; (3) applying leachate to the waste mass using a pressurized drip irrigation system; (4) allowing landfill gases to vent; and (5) adjusting air injection and re-circulated leachate to achieve a 40% to 60% moisture level and a temperature between 120° F. and 140° F. in steady state. One of the stated objectives of the Hudgins method, however, is to reduce the production of methane gas in the landfill. The Hudgins method thus does not provide a convenient way to produce methane for beneficial purposes.

### SUMMARY OF THE INVENTION

The method of injecting steam into landfills according to this invention has several features, no single one of which is solely responsible for its desirable attributes. Without limiting the scope of this invention as expressed by the claims that follow, its more prominent features will now be discussed briefly. After considering this discussion, and particularly after reading the section entitled “Detailed Description of the Drawings,” one will understand how the features of this invention provide advantages, which include minimization of the amount of liquid introduced into the landfill, total moisturization and higher overall humidity of the landfill without the need to apply head pressure, promotion of settlement of the landfill, heating of the refuse, avoidance of clogging of gas extraction collectors, ability to distribute gaseous anaerobic fertilizer throughout the trash prism, increased methane production, and production of methane having higher Btu values as compared to methane produced in other landfills.

The present method comprises injecting steam into a landfill and collecting the methane produced by the decomposition/biodegradation of the organic component of the trash prism. The steam accelerates the decomposition of the organic refuse, thereby enhancing methane gas production by increasing the purity of the methane. By accelerating the decomposition of the organic refuse, the steam also increases the rate of settlement of the landfill. The time necessary to convert the landfill into property that is useful for purposes besides waste disposal is thus reduced. The reduced decomposition time also reduces the impact of the landfill on the environment.

The steam is derived from a source such as a boiler, heat exchanger or power plant, and is injected into the landfill through an array of steam injection wells. The methane is collected through an array of gas extraction collectors distributed throughout the landfill. The wells and collectors preferably comprise steel push-in screens and risers. The optimal location for the wells and collectors is preferably determined using a piezo-penetrometer test (PPT) profile, and the wells and collectors are preferably installed in the landfill using the PPT rig. The injectors and collectors can, however, also be installed with a drill rig.

Temperature and moisture sensors are preferably distributed throughout the landfill to monitor the conditions within the landfill. Feedback from these sensors enables the amount of steam injection to be adjusted to prevent liquid from accumulating within the landfill.

In a further aspect of the present method, both air and steam are injected into the landfill in order to maintain the landfill in the aerobic phase. Injecting only air into the landfill for aerobic degradation dries out the trash prism, which slows the decomposition process and may cause subterranean fires. Thus, the moisture lost in this process must be replaced. Introducing water is disadvantageous because it cools the refuse, slowing degradation, and travels downward due to gravity. Steam, however, warms the refuse because of its high temperature. The steam, which is a vapor, also travels in all directions within the landfill just as the injected air does. Further, the air that is injected is usually cool, especially in winter. Heating the air stream will prevent the air from cooling the interior of the landfill. Steam provides this heating action.

In a further aspect of the present method, the steam serves as a carrier medium for a gaseous anaerobic fertilizer, such as ammonia or ammonia nitrate. The steam may also serve as a carrier medium for a gas, such as nitrous oxide, that speeds the conversion of the landfill from the aerobic phase to the anaerobic phase.

In a further aspect of the present method, the temperature and pressure of the injected steam are raised to a level sufficient to melt the plastic component of the trash prism, thereby promoting further settlement of the landfill. The temperature and pressure are preferably raised after substantially all of the organic component of the refuse has decomposed. After substantially all of the plastic has melted, the gas extraction collectors preferably draw off the remaining steam in order to prevent condensation within the landfill.

In a further aspect of the method, the conditions within the landfill are preferably monitored using a PPT profile. The rate of settlement, and the rate of organic decomposition provide important information about the effectiveness of the present method.

In a further aspect of the method, the volume of the plastic component of the refuse is reduced prior to placing the refuse within the landfill. The plastic is preferably melted by placing the refuse in a containerized trommel and applying high-temperature and high-pressure steam. If the plastic is to be recycled, it is preferably removed from the refuse using screens.

The present methods and apparatus of pre-treating refuse with steam prior to placing the refuse into a landfill have several features, no single one of which is solely responsible for their desirable attributes. Without limiting the scope of the present methods and apparatus, as expressed by the claims that follow, their more prominent features will now be discussed briefly. After considering this discussion, and particularly after reading the section entitled “Detailed Description of the Drawings,” one will understand how the features of the present methods and apparatus provide advantages, which include compaction of the refuse to increase or maximize use of airspace within the landfill, reduction in waste-handling equipment, maintenance and fuel, reduction in landfill site personnel, reduction in amount of cover soil used in the landfill, increase in profitability for landfill operators, rapid biodegradation of organic component of refuse, closer monitoring of refuse, and lesser environmental impact.

In an embodiment of the present methods and apparatus, a compaction station is provided. The compaction station includes a platform that is sized and configured to receive refuse. The refuse is moved from the platform into a compaction chamber by a hydraulic ram, which compresses the refuse inside the compaction chamber. The compaction station also includes a boiler that is configured to create steam and is in communication with at least one steam port. The steam port is configured to inject steam into the refuse. A steam extractor is also included; the steam extractor is configured to remove steam from within the compaction chamber and is in communication with the compaction chamber. The compaction station also includes a steam condenser that is in communication with the steam extractor. The steam condenser is configured to condense the steam into water and supply the water to the boiler.

In yet another embodiment of the present invention, a compaction station comprising is provided that includes a compaction chamber configured to receive steam. The compaction station also includes a steam extractor that is configured to remove steam from the compaction chamber. Also included is a press that is configured to compress refuse in the compaction chamber. In some embodiments, the compaction station also includes a platform. In further embodiments, the platform comprises an opening. Preferably, the platform is configured to rotate such that the refuse placed on the platform will engage a wiper that holds the refuse until the opening in the platform slides underneath the refuse. The opening permits the refuse to fall into a holding bin.

Also provided is a method of treating refuse prior to placement in a landfill. The method comprises the steps of depositing refuse on a platform of a compaction station and transferring the refuse from the platform to a compaction chamber. The compaction chamber is sealed and steam is injected into the refuse of a temperature and a pressure sufficient to melt plastics in the refuse and to vaporize liquids. The steam is then extracted from the compaction chamber and the refuse is compressed inside the compaction chamber, creating a refuse block. The refused block is cooled with water to solidify the block. The refuse block is transferred from the compaction chamber to a landfill.

Another method is provided for a compaction station. According to this method, high temperature steam is injected into refuse that is in a compaction chamber of the compaction station. The steam is then extracted from the refuse and the refuse is compressed into a refuse block.

### BRIEF DESCRIPTION OF THE DRAWINGS

The preferred embodiments of the present apparatus and methods for treating refuse with steam, illustrating its features, will now be discussed in detail. These embodiments depict the novel and non-obvious apparatus and methods shown in the accompanying drawings, which are for illustrative purposes only. These drawings include the following figures, in which like numerals indicate like parts:

FIG. 1 is a schematic top view of an apparatus for performing one preferred embodiment of the present method;

FIG. 2 is a schematic side view of the apparatus of FIG. 1;

FIG. 3 is a schematic top view of an apparatus for performing another preferred embodiment of the present method;

FIG. 4 is a schematic top view of an apparatus for performing another preferred embodiment of the present method;

FIG. 5 is a flow chart showing a method in accordance with an embodiment of the present invention;

FIG. 6A is a schematic side view of an embodiment of a compaction station having features in accordance with the present apparatus and methods;

FIG. 6B is a schematic side view of another embodiment of a compaction station having features in accordance with the present apparatus and methods;

FIG. 7 is a schematic top view of the compaction station of FIG. 6A, showing the travel of the press in phantom lines;

FIG. 8 is a schematic top view of a landfill or transfer station including at least one compaction station having features in accordance with the present apparatus and methods;

FIG. 9 is a schematic side view of a rail car transporting refuse blocks that have been treated with the present apparatus and methods; and

FIG. 10 is a schematic top view of another embodiment of a compaction station having features in accordance with the present apparatus and methods, showing a press of the compaction station in phantom lines.

### DETAILED DESCRIPTION OF THE PREFERRED EMBODIMENTS

In an embodiment of the present methods and apparatus, steam is injected into a landfill 10. The steam promotes the anaerobic biodegradation of the organic refuse in the landfill 10, which in turn increases methane gas generation and increases the rate of settlement of the landfill 10.

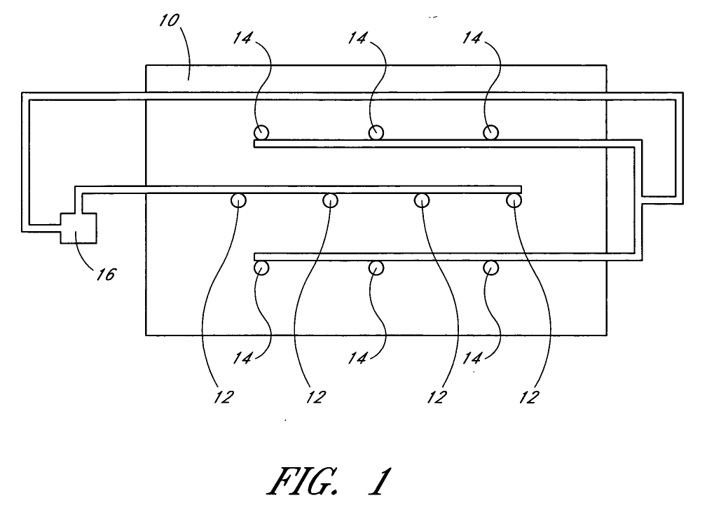

FIG. 1 schematically illustrates an apparatus for performing an embodiment of the present method. Several lines of steam injection wells 12 and several lines of gas extraction collectors 14 are positioned within a landfill 10. The arrangement depicted in FIG. 1 is merely exemplary. The ideal location for the injection wells 12 and gas collectors 14 is preferably determined prior to installing the steam injection apparatus, and may differ significantly from the arrangement of FIG. 1.

One preferred method of determining the ideal location for the steam injection wells 12 and gas collectors 14 is to perform a piezo-penetrometer test (PPT) profile on the landfill 10. The PPT profile is performed with a cone-shaped instrument having sensors that measure several parameters as the cone is hydraulically pushed into the landfill 10. The PPT profile provides information about the in-situ conditions of the landfill 10. The PPT rig may also be used to install the steam injection wells 12 and gas extraction collectors 14 following the PPT profiling.

After installation of the steam injection wells 12 and gas extraction collectors 14, steam injection commences through the injection wells 12. Low pressure centers are preferably created at the gas extraction collectors 14, as by attaching a header and blower system to the collectors 14, for example. The low pressure centers create currents within the trash prism that distribute the steam throughout the trash prism. Adjustment of the relative positions of the injectors 12 and collectors 14 enables the steam currents to be altered in case particular areas of the trash prism are not receiving steam.

The source of steam 16 may be a gas-fired boiler, or a heat exchanger on the gas flare. Preferably, however, the source of steam 16 is exhaust steam from a power plant, which may be more economical to harness as compared to steam specially produced for the landfill 10.

If a portion of the landfill 10 has been flooded, the water from this portion may be used to produce steam. By submersing a heater beneath the flooded portion, the water in the landfill 10 can be boiled out and directly injected back into the drier portion of the landfill 10. This process desirably removes only the excess water and volatile organic compounds from the landfill 10. Particulates, oils and metals remain in the landfill 10.

The steam injected into the landfill 10 raises the moisture content of the landfill 10. Moisture promotes the rapid decomposition of the organic portion of the trash prism, while at the same time raising the amount of methane gas produced during decomposition. The rapid decomposition of the organic refuse causes the rapid settling of the landfill 10, which shortens the amount of time that the landfill 10 is active. Once the landfill 10 has settled a sufficient amount, it is capped, and the land may thereafter be used for other purposes.

Injecting steam into the landfill 10 is more advantageous than injecting water for a variety of reasons. First, water expands to approximately 16,000 times its original volume upon boiling. Thus, injecting steam allows total coverage of the trash prism using only a small fraction of the water that would otherwise be needed. Using less water minimizes the potential for liquid to migrate to the bottom of the landfill 10 and into the groundwater, which could cause contamination.

Second, steam, which is a vapor, is under expansion pressure. Thus, it requires no head pressure, as water does, to move it through the trash prism. Steam also moves naturally with temperature differentials, from hot to cold areas. Total coverage of the landfill 10 can thus be achieved with minimal work input to the system. The more ready expansion of steam also creates better moisture distribution and higher overall humidity as compared to water. Water tends to flow down to the bottom of the landfill 10 and stay there. The lower portion of the landfill 10 is thus humid, while the upper portions, which contain the freshest refuse, remain dry. Because methane production within the landfill 10 increases with humidity, it is advantageous to maximize the humidity throughout the trash prism, rather than raising the humidity only near the bottom of the trash prism.

Third, steam, like all gases, is compressible. Water is not. Water thus occupies free space in the landfill 10, inhibiting settlement. As stated above, the landfill 10 desirably settles rapidly. The use of steam promotes more rapid settlement of the landfill 10 than does liquid water.

Fourth, steam, which is at a higher temperature than liquid water under the same pressure, will tend to increase, rather than reduce, the overall temperature of the landfill 10. Decomposition proceeds best at about 100° F. Steam thus tends to promote better decomposition by maintaining a higher temperature within the landfill 10. The high temperature steam also tends to melt plastics within the landfill 10, further speeding the rate of settlement of the landfill 10.

Fifth, liquids carry suspended solids and calcium carbonate, which tend to clog the gas extraction collectors 14 and bottom drains of landfills. Steam does not carry suspended solids or calcium carbonates, and so will not lead to clogging.

Sixth, steam may act as a carrier for various gaseous anaerobic fertilizers, such as ammonia, ammonia nitrate and nitrous oxide. This advantage is especially important for old landfills that have been sitting dry and dormant for long periods of time. These landfills generally require additional nutrients to encourage anaerobic bacterial activity.

To achieve these and other advantages, a preferred method of injecting steam into a landfill 10 comprises several lines of steam injection wells 12 and several lines of gas extraction collectors 14, as in FIG. 1. The injection wells and extraction collectors 14 are preferably 2″ steel push-in screens and risers, but could be any diameter to suit a particular application, and could be constructed from sturdy materials other than steel. The collectors 14 preferably include sensors for measuring certain parameters, such as flow rates, methane concentrations, and Btu values, in order to monitor the effectiveness of the steam injection method. The injectors 12 and collectors 14 are also preferably installed using the PPT rig, which can push them into the landfill 10 in a fraction of the time, and at a fraction of the cost required for drilling. The injectors 12 and collectors 14 could, however, be installed with a drill rig. Another advantage of push-in injectors 12 and collectors 14 is that they can be raised and lowered at any time to ensure that they are at the optimum depth.

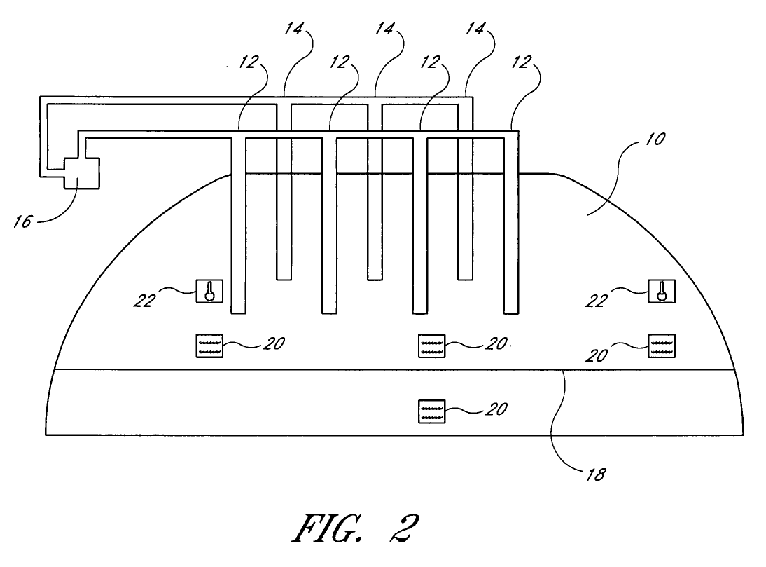

The PPT profile preferably determines the ideal placement and spacing for the injection wells and collectors 14. The PPT profile also preferably determines the depth of the screen interval, which will be above a dense layer 18 of the landfill 10, as shown in FIG. 2. Although a variety of arrangements are workable, the gas collector screens 14 are preferably installed between the injection wells 12, and at a depth somewhat above that of the injection wells 12. In this arrangement, the gas collectors 14 draw the steam and gas upward and away from the injection wells 12. Steam injectors 12 can also be installed around gas collectors 14 that are already in place in the landfill 10.

The PPT profile also preferably determines the ideal locations of moisture sensors 20 and temperature sensors 22, shown in FIG. 2. The arrangement depicted in FIG. 2 is merely exemplary, and the actual locations for the moisture sensors 20 and temperature sensors 22 may differ significantly from the arrangement of FIG. 2.

The moisture sensors 20 monitor the amount of liquid accumulating on the dense layer 18 below the injection wells 12. If liquid is detected, the amount of steam injected into the landfill 10 is reduced. The temperature sensors 22 monitor the movement of the steam through the trash prism. These sensors 22 provide closer monitoring of the conditions inside the landfill 10 than the moisture sensors 20. The information that they provide about landfill 10 conditions can be used to adjust the amount of steam injected in order to prevent liquid from accumulating on the dense layer 18, rather than adjusting the steam injection after liquid is detected.

Follow-up PPT profiles preferably monitor the decomposition of the organic material and the settlement between the dense layers 18. As the volume of the organic material between the dense layers 18 is reduced, the amount of steam is also reduced. This reduction helps prevent any liquid from accumulating on the dense layers 18.

The initial PPT profile also preferably surveys the elevation of the top deck of the landfill 10. This data enables monitoring of the overall settlement of the landfill 10.

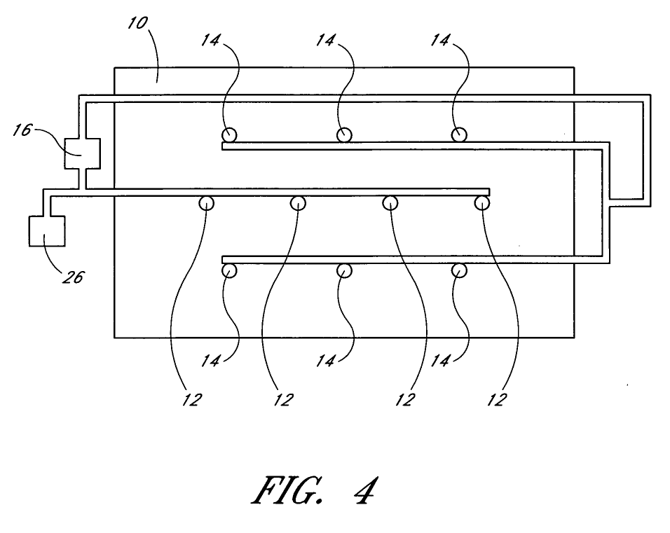

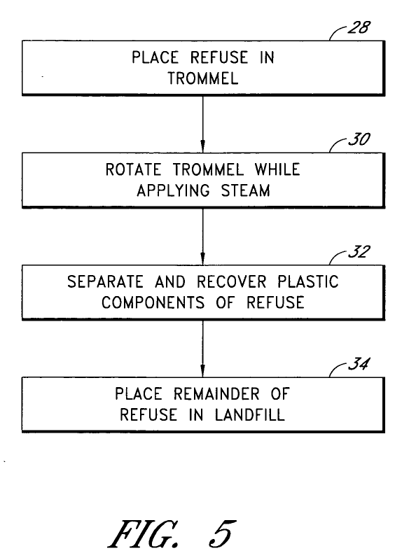

This method assumes that the landfill 10 is in its anaerobic phase. A method of injecting during the aerobic phase is depicted in FIG. 4. A blower 26 forces air along with the steam into the landfill 10 through the injection wells 12. The collectors 14 create localized low pressure zones, drawing the steam through the landfill 10. Because the landfill 10 is in the aerobic phase, little or no methane is produced by the decomposition of the organic refuse. Thus, rather than collecting methane and transporting it to a storage area, the collectors 14 instead collect steam from the landfill 10 and transport it back to the steam source 16, such as a boiler, heat exchanger or power plant.

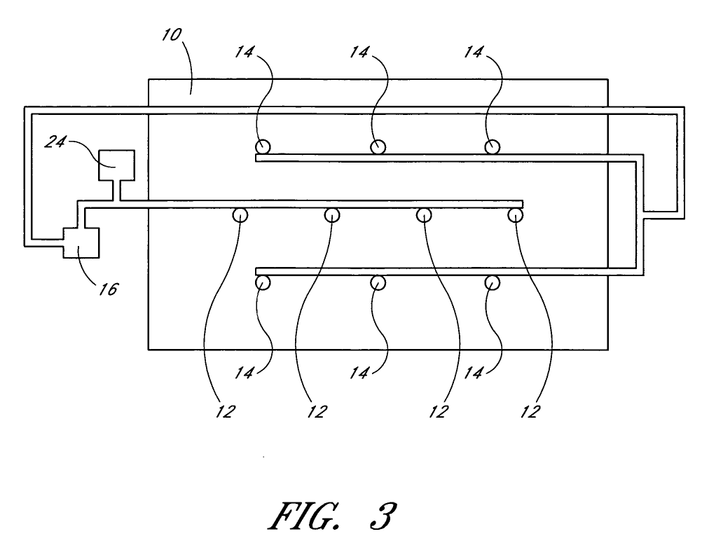

Another preferred method of injecting steam into a landfill 10 proceeds as in the previous methods, but the steam includes an anaerobic gas fertilizer 24. One or more gaseous fertilizers 24 are preferably introduced into the steam as it emerges from the boiler, heat exchanger, etc, as illustrated in FIG. 3. If the landfill 10 is still in the aerobic phase, the introduction of nitrous oxide assists in depleting the oxygen within the landfill 10, which accelerates the transition to the anaerobic phase. If the landfill 10 is already in the anaerobic phase, the introduction of ammonia and/or ammonia nitrate promotes the growth of anaerobic bacteria, which accelerate the biodegradation of the organic material in the landfill 10.

Another preferred method of injecting steam into a landfill 10 comprises raising the temperature and pressure of the steam following the biodegradation of the organic component of the refuse and the recovery of most of the methane. The temperature is preferably increased to a level sufficient to melt most of the plastic in the landfill 10. However, the plastic is preferably melted without combustion, so that toxic fumes are not produced. With plastic comprising 20% to 30% of the volume of a typical landfill 10, and plastic shrinking to 50% of its original volume upon melting, the temperature increase recovers up to 15% of the volume of the landfill 10.

To increase the pressure within the landfill 10, the valves on the gas collectors 14 are preferably closed. The increased pressure raises the temperature within the landfill 10. When the temperature reaches approximately 400° F. to 600° F. at the midpoint between the injectors 12 and collectors 14, the valves on the gas collectors 14 are preferably opened. The opening creates a pressure gradient that drives the steam toward the gas collectors 14. Steam at this temperature is considered dry. Most of it is recoverable through the collector system prior to condensing inside the landfill 10. The negative consequences of over-saturating the landfill 10 are thus avoided, despite injecting a relatively large amount of steam into the landfill 10.

In another preferred method, the volume of the plastic component of the refuse is reduced before the refuse is placed in a landfill. The refuse is preferably placed in a containerized trommel, into which high-temperature and high-pressure steam is injected as the trommel is rotated. To recycle the plastic, screens are preferably placed inside the trommel so that the plastic sticks to them. To recover the plastic, the screens are removed. According to this method, the organic component of the refuse is thoroughly moisturized by the steam prior to being placed in the landfill. The pre-moisturization further accelerates the bio-degradation of the organic refuse once it is buried in a landfill.

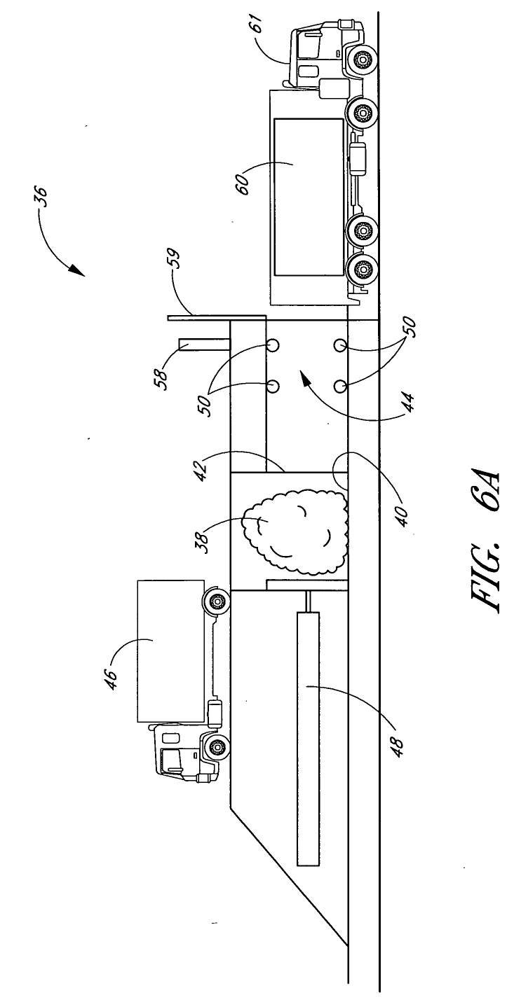

FIGS. 6A-10 illustrate further preferred methods and apparatus for pre-treating and compacting refuse before placing the refuse in a landfill. These methods and apparatus provide a compaction station 36 in which the refuse is treated with high-temperature and high-pressure steam. The steam melts the plastic content of the refuse, thereby reducing its volume, and the compaction station further reduce the refuse volume by compressing the refuse into blocks. This embodiment preferably has three phases: a loading and preparation phase, a compressing phase, and a transferring phase.

During the loading and preparation phase, the refuse 38 is placed on a platform 40 adjacent to an opening 42 of a compaction chamber 44, as shown in FIGS. 6A and 6B. While FIG. 6A illustrates a garbage truck 46 delivering the refuse 38 to the platform 40, those of skill in the art will appreciate that alternative apparatus, such as a front loader (not shown), may deliver the refuse 38.

Preferably, after the refuse 38 is placed on the platform 40, the organic content of the refuse 38 is determined. For example, infrared scanners or other sensors may perform this step. The content information may be used to determine the ramming force that will be applied to compress the refuse 38.

Once the content information is obtained, the refuse 38 is then moved into the compaction chamber 44. The refuse 38 may be moved into the compaction chamber 44 by a front loader, a conveyer belt, or other suitable apparatus. In a preferred embodiment, the refuse 38 is moved into the compaction chamber 44 by one or more hydraulic rams 48. The ram 48 moves the refuse 38 into the compaction chamber 44, but preferably does not compress the refuse 38 at this juncture.

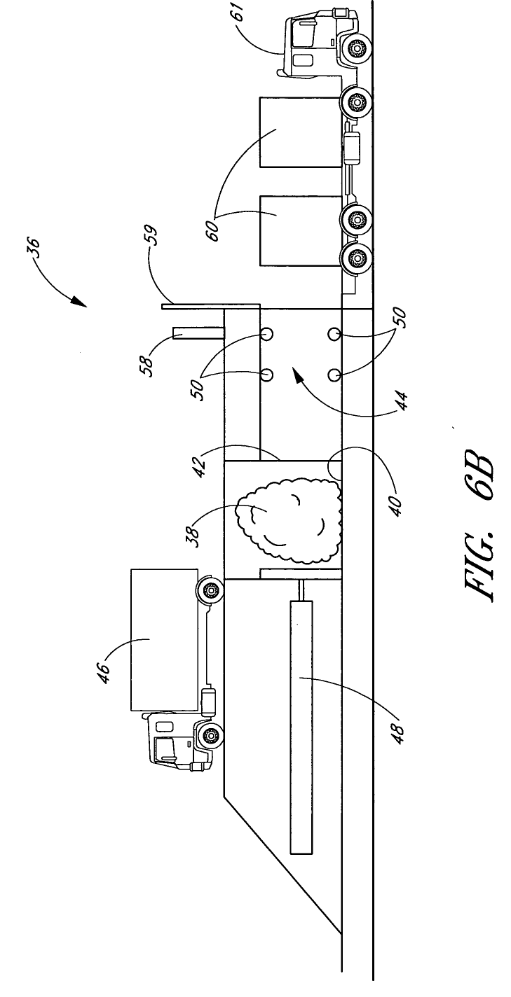

With reference to FIG. 7, after the refuse 38 enters the compaction chamber 44, the compaction chamber 44 is preferably sealed and high-temperature and high-pressure steam is injected into the chamber 44. Preferably, the steam is injected into the compaction chamber 44 through steam ports 50 (FIGS. 6A, 6B and 7) opening into the compaction chamber 44. The steam ports 50 communicate with steam lines 52 that supply steam to the compaction chamber 44. Preferably, a boiler 54 heats and pressurizes the steam before it is injected into the compaction chamber 44. Different types of boilers 54 may be used, as described above and as known by those of ordinary skill. Water is preferably supplied to the boiler 54 by a steam extractor and condenser 56 through water lines 55.

The steam is injected into the compaction chamber 44 until the refuse 38 reaches a desired temperature. The time required to heat the refuse 38 to the desired temperature depends upon the initial temperature of the refuse 38, which may depend upon the climate of the geographic location of the compaction chamber 38. In some embodiments, the temperature of the refuse 38 may vary between about 200 and 500° F. However, in some embodiments the temperature of the refuse 38 may be substantially less than 200° F., and in other embodiments the temperature of the refuse 38 may be substantially greater than 500° F. If the temperature of the refuse 38 remains above about 250° F., any free liquids in the refuse 38 will advantageously turn to steam.

After the refuse 38 reaches the desired temperature, the steam is preferably extracted from the compaction chamber 44 through a steam recovery line 58 (FIGS. 6A, 6B and 7). The steam recovery line 58 provides fluid communication between the chamber 44 and the steam extractor and condenser 56. The steam that is extracted from the compaction chamber 44 may be condensed to water in the steam extractor and condenser 56. The water may then be supplied to the boiler 54 for subsequent refuse treatment. The steam is preferably drawn out of the compaction chamber 44 by vacuum, although the inherent pressure difference between the compaction chamber 44 and the steam extraction and condenser 56 may also draw the steam from the chamber 44. With the compaction chamber 44 sealed, the compaction chamber 44, steam extractor and condenser 56, and the boiler 54 may comprise a closed system, preventing leakage of the steam or other liquids.

As the steam is extracted, the compression phase preferably begins. Extracting steam from the compaction chamber 44 reduces the pressure within the chamber 44. As the steam is extracted, the hydraulic ram 48 preferably advances into the chamber to compact the refuse 38 according to the content information previously obtained. While FIGS. 6A-7 illustrate the same ram for moving the refuse 38 into the compaction chamber 44 as used for compressing the refuse 38, those of skill in the art will appreciate that two or more rams may be used.

The pressure for compressing the refuse 38 may vary depending on the content of the refuse 38. In some embodiments, the compression pressure may vary from about 150 pounds per square inch (PSI) to about 750 PSI. However, in other embodiments the compression pressure may be significantly less than 150 PSI, while in other embodiments the compression pressure may be significantly greater than 750 PSI. In one embodiment, the compression pressure may be about 200 PSI.

After the refuse 38 has been compressed, the refuse 38 comprises a block 60 (FIGS. 6A and 6B). In an intermediate step not illustrated in the Figures, the block 60 occupies the chamber 44. During this step, the block 60 and the compaction chamber 44 may be cooled. For example, water jackets (not shown) in the walls of the chamber 44 may provide cooling. The steam extractor and condenser 56 may supply the water for the jackets, or another source may supply the water.

The refuse block 60 is preferably cooled to about 200° F. Cooling the refuse block 60 may harden the plastic in the block, which will help the block 60 retain its compacted shape. Cooling the walls of the compaction chamber 44 may also prevent the next refuse load from reacting prematurely to the heat.

Once the refuse block 60 is cooled, a door 59 (FIGS. 6A and 6B) of the compaction chamber 44 is opened and the block 60 exits the chamber 44. The hydraulic ram 48 may push the block 60, as shown in FIGS. 6A-7, or other apparatus may remove the refuse block 60 from the chamber 44. For example, a conveyer belt or a loader may remove the refuse block 60. In one embodiment, the refuse block 60 may be placed on a roll-off bin that may be transported to a rail yard or shipyard.

The compaction chamber 44 may be configured to produce refuse blocks 60 of various sizes. For example, in one embodiment, the compaction chamber 44 may be sized and configured such that forty-ton refuse blocks 60 are produced. In another embodiment, the compaction chamber 44 may be sized and configured such that twenty-four-ton refuse blocks 60 are produced. In yet another embodiment, the compaction chamber 44 may be sized and configured such that one-hundred-ton refuse blocks are produced. In further embodiments, the compaction chamber 44 may be sized and configured such that virtually any other size of refuse blocks 60 may be produced, and a single compaction chamber 44 may be sized and configured to produce refuse blocks 60 of various sizes.

Transportation vehicles 61 (FIGS. 6A and 6B) may receive the blocks 60 for transportation to a landfill. One vehicle 61 may transport a single block, as in FIG. 6A, or one vehicle 61 may transport multiple blocks, as in FIG. 6B.

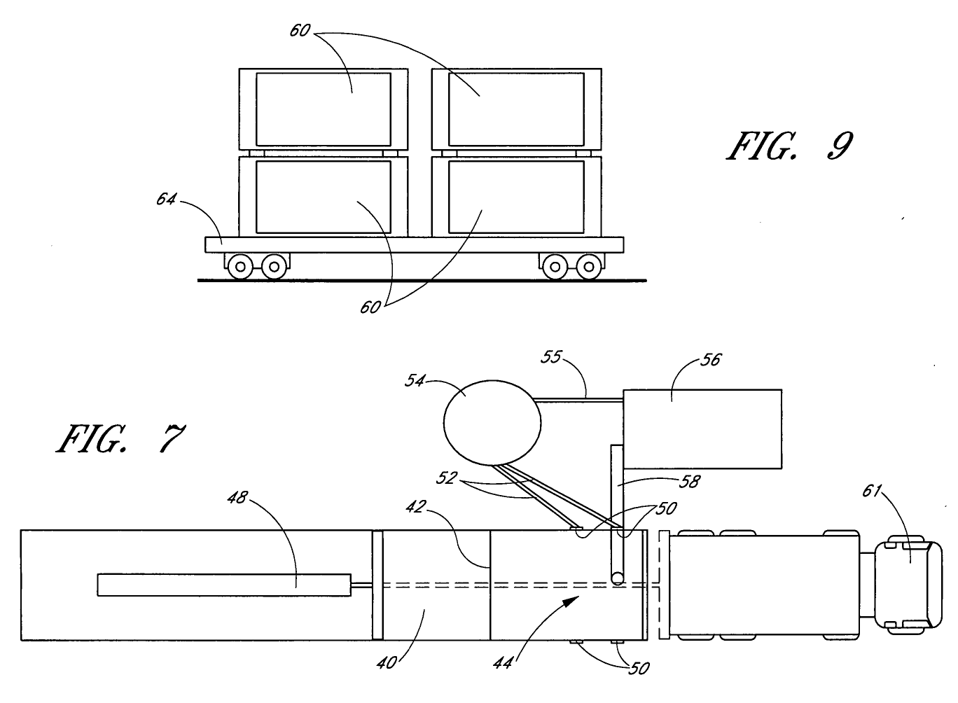

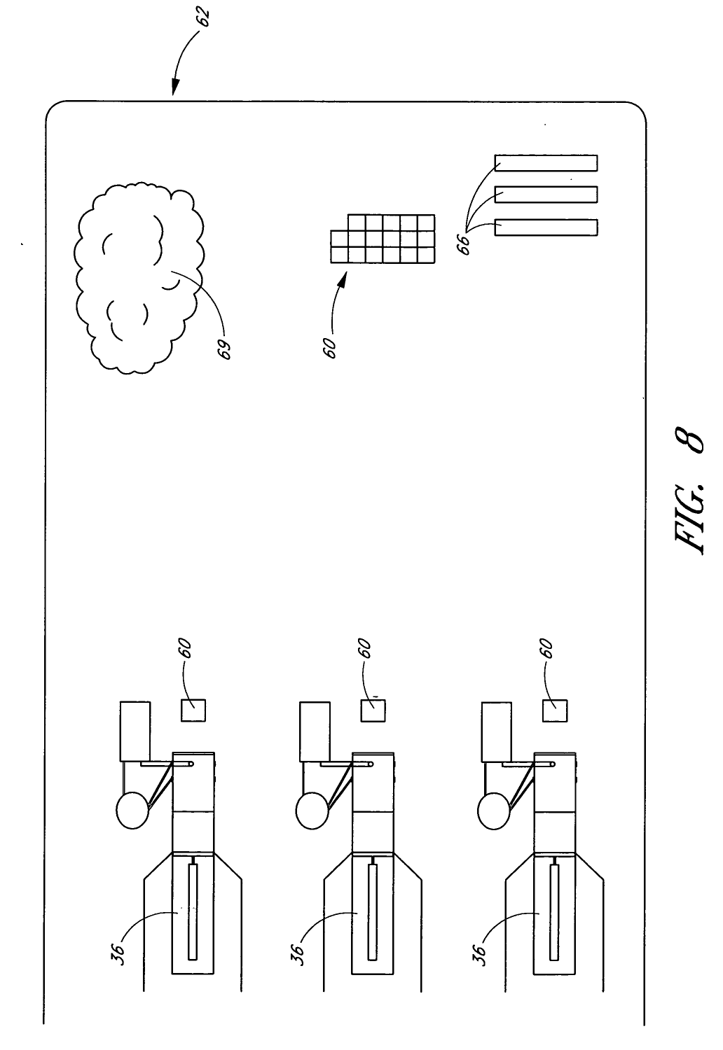

During the transportation phase, the refuse block 60 exits the compaction station 36. The location of the compaction station 36 may determine the apparatus used to transport the refuse block 60 to the landfill. If the compaction station 36 is located near the landfill 62, as shown in FIG. 8, the refuse block 60 may be transported to the appropriate location in the landfill 62 by truck, loader or similar apparatus, for example. If, however, the landfill 62 is a great distance from the compaction station 36, the refuse block 60 may be transported to the landfill 62 by truck, rail, as shown in FIG. 9, or barge, for example. When the refuse block 60 is transported by rail, the blocks 60, in one embodiment, may be loaded according to FIG. 9, with four refuse blocks 60 per rail car 64. Transportation by rail may be preferred to due to cost and highway load limitations. However, highway transportation may also be preferred for other considerations. Additionally, the compaction stations 36 may be located at rail intermodals or barge intermodals and transferred to rail cars or barges.

When the refuse blocks 60 are placed in the landfill 62, as shown in FIG. 8, they may be covered with a tarp 66, which facilitates aerobic degradation. When a determined area has been filled with enough refuse blocks 60, the blocks 60 may then be covered with a thin layer of soil. The landfill 62 may also include a holding area 69, also shown in FIG. 8, in case a compaction station 36 requires maintenance. The compaction stations 36 may be placed in close proximity to the landfill 62, or they may be provided at a transfer station (not shown). When the compaction stations 36 are provided at transfer stations, suitable apparatus for transportation may be provided to transfer the refuse blocks 60 to the landfill, as discussed above.

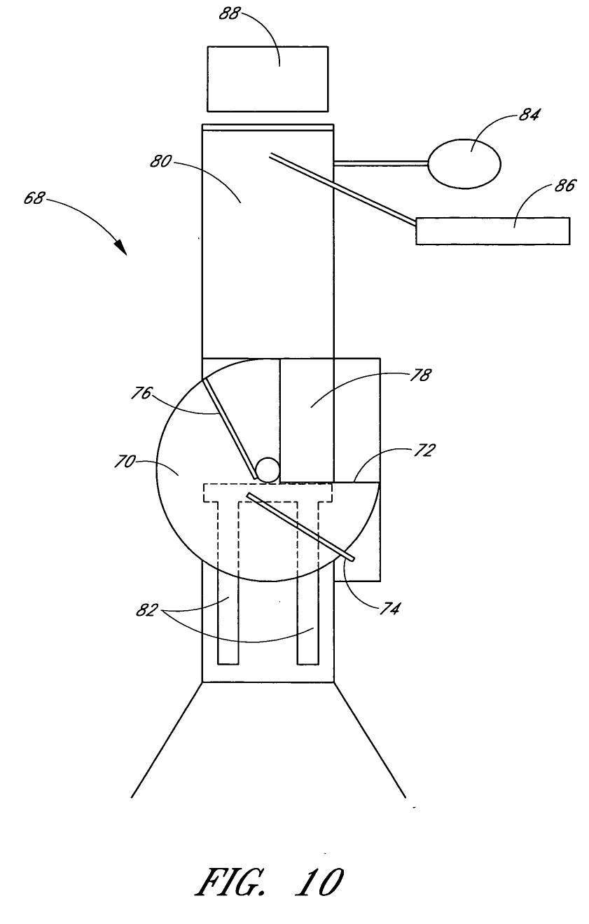

FIG. 10 illustrates another embodiment of the present methods and apparatus. This embodiment provides an automated compaction station 68. Preferably, the refuse (not shown) is placed on a rotatable platform 70. The platform 70 preferably rotates either clockwise or counter-clockwise and has an opening portion 72. The opening 72 is preferably large enough to permit large amounts of refuse to pass through.

The embodiment illustrated in FIG. 10 preferably rotates in the counter-clockwise direction. Refuse is placed on the rotatable platform 70, and as the platform 70 rotates, the refuse passes under a scanning arm 74. The scanning arm 74 preferably uses infrared or similar sensors to determine the content of the refuse. The feedback from the sensors may be used to determine the amount of volatile organic compounds and other undesirable materials. The scanning arm 74 may also record the feedback, if desired. Preferably, as the refuse rotates with the table, the refuse will eventually engage a wiper 76. The wiper 76 is preferably stationary such that when the refuse engages the wiper 76, the refuse will accumulate against the wiper 76. When the opening portion 72 of the platform 70 passes underneath the refuse that has accumulated against the wiper 76, the refuse falls through the opening 72 into a holding bin or a hopper 78.

Once the refuse enters the hopper 78, the phases for preparing, compressing, and transferring the refuse may proceed as described above. For example, the refuse may be advanced into the compaction chamber 80 by a hydraulic ram 82. The boiler 84 preferably supplies the chamber 80 with steam that is introduced through ports in the chamber 80. Following the steam treatment, the steam may be evacuated from the chamber 80 to a condenser 86 where the steam may be condensed into water and subsequently supplied to the boiler 84. During or following extraction of the steam, the refuse is preferably compressed by the hydraulic ram 82 into a refuse block 88. Following compaction, the refuse block 88 may be cooled and transported to a desired location. All of the above operations may be video taped for future reference.

The hopper 78 may be sized and configured to provide an operator with visual feedback on the amount of refuse placed therein. For example, in one embodiment, the hopper 78 may be substantially the same size as the compaction chamber 80. In this embodiment, the operator may know that there is sufficient refuse for the compaction chamber 80 by simply filling the hopper 78. In some embodiments, there may be markings in the hopper 78 that provide similar feedback to the operator.

Many advantages may be realized by compacting the refuse according to the methods and systems discussed previously. The compacted refuse increases or maximizes use of landfill airspace. Rather than compacting the refuse by driving heavy and costly equipment over the refuse, a desirable refuse density is achieved before the refuse is even placed in the landfill. Instead of going through multiple compaction processes, the present apparatus and methods compact the refuse only once. As the airspace in the refuse decreases, the amount of cover soil needed for the landfill also decreases, because cover soil does not fill the airspace in the refuse that existed prior to compaction.

Another benefit of the present apparatus and methods is the reduction in water that is transported with the refuse. While prior art methods leave liquids in the refuse, the present apparatus and methods vaporize liquids existing in the refuse as the steam heats the refuse. The vaporized liquids mix with the steam and are thereafter evacuated from the chamber along with the steam. Consequently, when the refuse is transported, it contains less liquid than it did prior to the compaction process. The extracted liquid may be stored for later use or recycled for the next compaction process.

Further advantages of the present apparatus and methods include increased moisture treatment of the refuse for rapid biodegradation, increased ability to monitor the refuse and its contents, reduced odor when the refuse blocks are transported to landfills, and reduced amount of waste-handling equipment, maintenance, and fuel. In transporting the refuse, increased or maximum loads may be obtained for trucks, trains, and barges. Even further, transfer stations may be converted to or include a steam compaction station, and the stations may include roll-off bins that can readily be transported to the rail yard or shipyard.

### Scope of the Present Invention

The above presents a description of the best mode contemplated for carrying out the present apparatus and methods for treating refuse with steam, and of the manner and process of making and using the same, in such full, clear, concise, and exact terms as to enable any person skilled in the art to which it pertains to make and use these apparatus and methods. These apparatus and methods are, however, susceptible to modifications and alternate constructions from that discussed above which are fully equivalent. Consequently, it is not the intention to limit these apparatus and methods to the particular embodiments disclosed. On the contrary, the intention is to cover all modifications and alternate constructions coming within the spirit and scope of these apparatus and methods as generally expressed by the following claims, which particularly point out and distinctly claim the subject matter of these apparatus and methods.

What is claimed is:

1. A compaction station comprising:
a platform sized and configured to receive refuse;
a hydraulic ram configured to move refuse into a compaction chamber and compress the refuse inside the compaction chamber;
a boiler configured to create steam and in communication with at least one steam port, the at least one steam port being configured to inject steam into the refuse;
a steam extractor configured to remove steam from within the compaction chamber, the steam extractor being in communication with the compaction chamber; and
a steam condenser in communication with the steam extractor, the steam condenser being configured to condense the steam into water and supply the water to the boiler.

2. The compaction station of claim 1, wherein the platform is rotatable.

3. The compaction station of claim 1 further comprising a scanner configured to scan the refuse treated by the compaction station.

4. A compaction station comprising:
a compaction chamber, the compaction chamber being configured to receive steam;
a steam extractor configured to remove steam from the compaction chamber; and
a press configured to compress refuse in the compaction chamber.

5. The compaction station of claim 4 further comprising a platform for holding the refuse.

6. The compaction station of claim 5, wherein the platform comprises an opening, and the platform is configured to rotate such that the refuse placed on the platform will engage a wiper that holds the refuse until the opening in the platform slides underneath the refuse, permitting the refuse to fall into a holding bin.

7. The compaction station of claim 4 further comprising a scanner that is configured to scan the refuse treated by the compaction station.

8. A method of pre-treating refuse before placement of the refuse in a landfill, the method comprising the steps of:
depositing refuse on a platform of a compaction station and transferring the refuse from the platform to a compaction chamber;
sealing the compaction chamber and injecting steam into the refuse of a temperature and a pressure sufficient to melt plastics in the refuse and vaporize liquids;
extracting the steam from the compaction chamber and compressing the refuse inside the compaction chamber, creating a refuse block;
cooling the refuse block with water to solidify the refuse block and transferring the refuse block from the compaction chamber to a landfill.

9. The method of claim 8 further comprising the step of scanning the refuse before the refuse is transferred into the compaction chamber.

10. A method of treating refuse, the method comprising the steps of:
providing a compaction station for treating the refuse;
injecting high temperature steam into refuse in a compaction chamber of the compaction station;
extracting the steam and compression the refuse into a refuse block.

11. The method of claim 10 further comprising the step of transferring the refuse block to a landfill.

12. The method of claim 11, wherein the refuse block is transferred by truck.

13. The method of claim 11, wherein the refuse block is transferred by rail.

14. The method of claim 11, wherein the refuse block is transferred by barge.

15. The method of claim 10 further comprising the step of cooling the refuse block following compaction.

16. The method of claim 10, wherein the refuse block is compressed by a hydraulic ram.

17. The method of claim 10, wherein the refuse is treated by the compaction station at a transfer station.

18. The method of claim 10, wherein the refuse is treated by the compaction station at a landfill.
